(19) United States
(12) Patent Application Publication
(10) Pub. No.: US 2010/0059496 A1
(43) Pub. Date: Mar. 11, 2010

(54) METAL SHEATH GLOW PLUG

(75) Inventors: Camillo Rena, Mondovi (IT); Sandro Goretti, Rubiera (IT); Marcello Cino, Rubiera (IT); Laura Beretta, Modena (IT)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL IGNITION COMPANY, Southfield, MI (US)

(21) Appl. No.: 12/206,261

(22) Filed: Sep. 8, 2008

(51) Int. Cl. F23Q 7/22; H05B 3/00

(52) U.S. Cl. 219/270; 29/611

(57) ABSTRACT

A glow plug (10) which includes an annular metal shell (12), thermally conductive tubular sheath (20), electrode (22), resistance heating element (24), and electrically insulating, thermally conductive powder (26). A metallic seal (28) is disposed in an open end of the sheath (20) in sealing engagement with the electrode (22). An insulating layer (54) is formed on the outer surface of the electrode (22) so as to prevent electrical conductivity between the metal seal (28) and the electrode (22). An optional secondary metal layer (56) may be disposed between the insulating layer (54) and the metal seal (28).

### CROSS REFERENCE TO RELATED APPLICATIONS

None.

### BACKGROUND OF THE INVENTION

1. Field of the Invention

This invention relates generally to glow plugs and more particularly to sheathed metallic glow plugs.

2. Related Art

Sheath glow plugs typically have an electrical resistance heater which includes one or more spiral wound resistive wire, embedded in an electrically insulating, thermally conductive powder so as to be electrically isolated from the tubular sheath they are located in except for electrical connection to the free closed end of the sheath. Glow plugs of the type described are, for example, disclosed in U.S. Pat. No. 4,963,717. The electrical resistance wire(s) located in the sheath are totally embedded in the insulating powder, and the insulating powder is sealed in the sheath using an elastomeric o-ring seal or other seal device. These o-ring seals have been made using various elastomers, including fluoropolymers such as those sold by DuPont under the Viton® brand. While o-ring seals have been used in many glow plug applications, their useful operating temperature range is about 150-200° C., which is now proving to be a constraint. Recently, glow plug applications have been emerging where a higher operating temperature range is needed and the prior art 0-ring seals are not suitable.

In addition, even when operating within the previous lower operating temperature range, O-ring seals are not hermetic and as a result oxygen and water vapors can permeate into the insulating powder and resistance heating element to cause oxidation, cracking and eventually failure. This failure mode can serve to reduce or otherwise limit the operational life of the glow plug.

In view of the above, there exists a need for glow plugs that can be used at operating temperatures in the region of the seal above 200° C., and, that can provide a true harmonic seal between the electrode and the sheath.

### SUMMARY OF THE INVENTION

This invention provides a glow plug comprising a metal shell having an axially extending bore. An electrically and thermally conductive tubular sheath is supported in the shell. The sheath has an open end disposed within the shell bore and a closed end projecting out from the bore. An electrode has an embedded section that extends through the shell into the open end of the sheath. The embedded section is provided with a discreet insulating layer. A resistance heating element is disposed in the sheath and has a proximal end electrically connected to the embedded section of the electrode, and a distal end electrically connected to the closed end of the sheath. An electrically insulating, thermally conductive powder is disposed within the sheath and surrounds the embedded end of the electrode and the resistance heating element. A metal seal is formed in the open end of the sheath, in hermetic sealing engagement between the sheath and the insulating layer of the electrode. The metal seal provides improved sealing of the electrode so as to prevent external substances entering the sheath during manufacturing or use. Furthermore, the metal seal is effective to eliminate the infiltration of air or oxygen into the sheath, thereby extending the working life of the glow plug assembly.

According to another aspect of this invention, a glow plug as described above further includes a secondary metal layer disposed over the insulating layer on the electrode, with the metal seal in sealing engagement between the sheath and the secondary metal layer.

According to a still further aspect of this invention, a method is provided for making a heating assembly for a glow plug which includes an electrically and thermally conductive tubular sheath having an open end and a closed end, an electrode having an embedded section extending into the open end of the sheath, the embedded section having an insulating layer thereon, an electrically insulating and thermally conductive powder disposed within the sheath and surrounding the resistance heating element, and a metal seal disposed in the open end of the sheath in sealing engagement between the sheath and the insulating layer. The method comprises the steps of forming a tubular sheath, electrode and resistance heating element, and then forming an insulating layer on at least a portion of the embedded section of the electrode. One end of the resistance heating element is attached to the embedded section of the electrode. The resistance heating element is inserted along with the embedded section of the electrode into the tubular sheath. Another end of the resistance heating element is attached to the closed end of the sheath. Powder is inserted into the sheath around the resistance heating element, and then a metal seal is formed between the sheath and the insulating layer.

### BRIEF DESCRIPTION OF THE DRAWINGS

These and other features and advantages of the present invention will become more readily appreciated when considered in connection with the following detailed description and appended drawings, wherein:

FIG. 1 is a partial cross-sectional view of a sheathed heater assembly and glow plug according to the subject invention;

FIG. 2 is an enlarged fragmentary view of the heater assembly in cross- section;

FIG. 3 is a cross-sectional view through the metal seal as taken generally along lines 3-3 in FIG. 2;

FIG. 4 is a fragmentary view of an alternative embodiment of this invention wherein a secondary metal layer is disposed between the metal seal and the insulating layer on the electrode;

FIG. 5 is a cross-sectional view taken generally along lines 5-5 in FIG. 4;

FIG. 6 is a cross-sectional view of the sheath depicted in a preform condition;

FIG. 7 is an enlarged view of the resistance heating element; and

FIG. 8 is a flow chart depicting an assembly operation for manufacturing a glow plug according to this invention.

### DETAILED DESCRIPTION OF THE PREFERRED EMBODIMENT

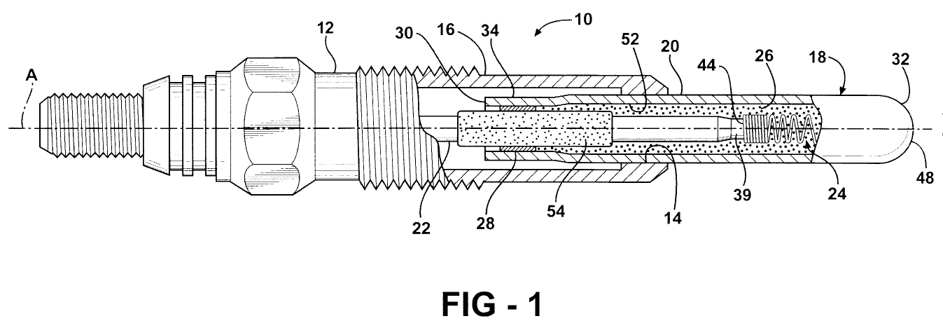

Referring to the Figures, wherein like numerals indicate like or corresponding parts throughout the several views, a glow plug manufactured according to a first embodiment of this invention is generally shown at 10 in FIG. 1. The glow plug 10 includes an annular metal shell 12 having a bore 14 which extends along a longitudinal axis A. The shell 12 may be formed from any suitable metal, such as various grades of steel. The shell 12 may also incorporate a plating or coating layer, such as a nickel or nickel alloy coating over some or all of its surfaces including the exterior surface 16 and the bore 14 so as to improve its resistance to high temperature oxidation and corrosion.

Conventional metallic sheath glow plugs (not shown) utilize an elastomeric or plastic seal, such as an o-ring seal, between the electrode and the grounded sheath portion of the heating tip. Such elastomeric seals have limited service life because of degradation in performance due to oxidation of the heating element, which is typically a spiral wire resistance heating element inside the sheath. The heating element is usually packed in a bed of magnesium oxide powder and sealed with the rubber or plastic gasket. During thermal cycling, which occurs during operation of the glow plug, the surface of the wire oxidizes, reducing the effective cross-section of the wire and eventually leading to a higher current density in this portion of the wire. As a result, overheating of the wire and failure of the heating element is likely. A factor affecting this mode of operation is imperfect seal of the rubber or plastic gaskets, which allows oxygen and water vapor to diffuse into the packed powder bed and react with the heating element wire, resulting in oxidation and the reduction in effective cross-section described above. Reaction of the magnesium oxide with the water vapor may form magnesium hydroxide, which can corrode or oxidize the metal wire to cause failure of the part even when the glow plug is not in service. Other materials that are absorbed into the surface of the magnesium oxide powder may also contribute to the degradation of the resistance heating element wire.

In contradistinction, the subject invention comprises a glow plug 10 having an improved heater assembly 18 which reduces the exposure of its packing powder and its spiral wire resistance heating element embedded in the powder to oxygen and water vapor, thereby eliminating or substantially reducing the degradation process described above.

The subject heater assembly 18 includes a sheath 20, electrode 22, resistance heating element 24, powder packing material 26 and a seal 28. As used herein, references to proximal and distal are with reference to the end of the glow plug 10 which is away from the sheath 20, with proximal being closer to this end and distal being relatively farther from this end.

The sheath 20 is an electrically and thermally conductive member of generally tubular construction. Any suitable metal may be used to form the sheath 20, but metals having a resistance to high temperature oxidation and corrosion are preferred, particularly with respect to combustion gases and reactant species associated with the operation of an internal combustion engine. An example of a suitable metal alloy is a nickel-chrome-iron-aluminum alloy. The sheath 20 has an open end 30 disposed within the bore 14 and in electrical contact with the shell 12. The sheath 20 also has a closed end 32 which projects away from the bore 14. Preferably, the sheath 20 has an outer diameter (D1) that varies along its length such that the outer diameter has a reduced diameter portion 34 proximate the open end 30. The outer diameter D1 may be any suitable diameter. An example of a typical outer diameter D1 for many glow plug applications is about 4 mm. Reduced diameter portion 34 is generally somewhat longer than the length of the seal 28. In an exemplary embodiment, the axial length of the reduced diameter portion 34 is about 8 mm. The radial distance between the outer diameter D1 and the reduced diameter portion 34 may be any amount, but in an exemplary embodiment is about 0.4 mm.

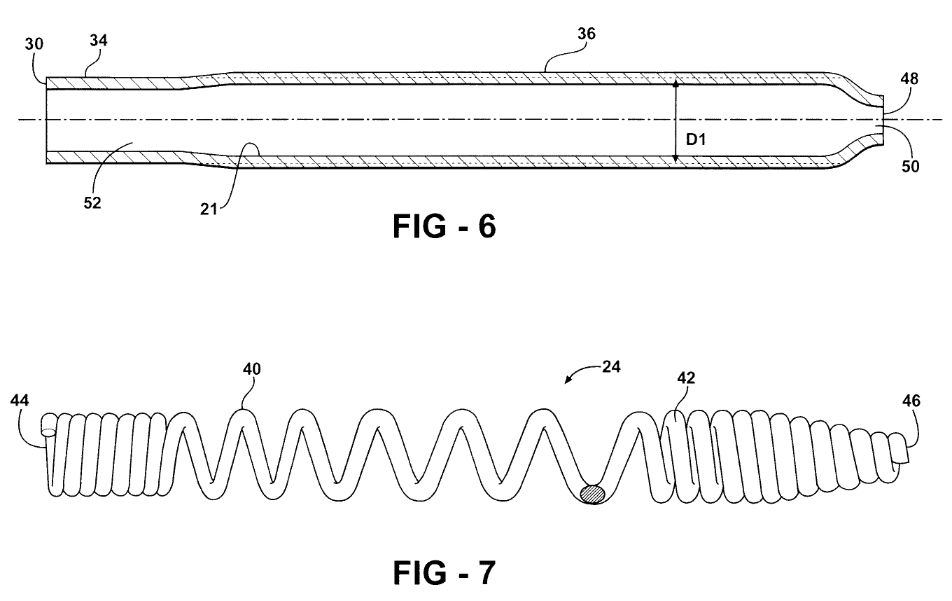

The sheath 20 may have a deformed microstructure, such as a cold-worked microstructure, where a sheath preform, generally indicated at 36 in FIG. 6, is reshaped by swaging or otherwise to reduce the diameter and increase the density of the powder in the sheath. In an exemplary embodiment, deformation may amount to about a 20 percent reduction in the wall thickness of the sheath preform 36, as shown by broken lines in FIG. 6. The inner surface 21 of the sheath 20 proximate the seal 28 will be cleaned thoroughly prior to incorporation of the heater assembly 18 to remove volatile contaminants such as oils. The inner surface 21 may also be oxidized for adhesion benefit. When an oxide layer is developed for this purpose, it will typically be in the range of 0.2-5.0 microns in thickness.

The electrode 22 has an embedded section that extends into the open end 30 of the sheath 20. The electrode 22 may be made from any suitable electrically conductive material, but is preferably a metal or even more preferably made from steel. Examples of suitable grades of steel include AISI 1040, AISI 300/400 family, EN 10277-3 family, Kovar *UNS K94610 and ASTM F15, 29-17 alloy. The resistance heating element 24 may be any suitable resistance heating device, including a wound or spiral wire resistance heating element as best shown in FIG. 7. The resistance heating element 24 may have any suitable resistance characteristics so long as it is operable to provide the necessary time/temperature heating response characteristics needed for a specified application of the glow plug 10. This may include an element comprising a single (i.e., homogonous) electrical resistance element with a positive temperature coefficient characteristic (PTC characteristic), or a dual construction in which two series-connected electrical resistance elements are joined end to end. In this latter scenario, a first resistance element 40 is connected to the electrode 22 and fabricated from a material having a higher PTC characteristic than a second resistance element 42 which is connected to the closed end of the sheath 20. Thus, the first resistance element 40 acts as a current limiter or regulator element, while the second resistance element 42 acts as the heating element. Spiral wire resistance heating elements may be formed from any suitable material, including various metals such as pure nickel and various nickel, nickel-iron-chromium and iron-cobalt alloys to name but a few. Referring again to FIGS. 1 and 7, a spiral wire, dual resistance element heating element 24 is disposed in the sheath 20 with a proximal end 44 which is electrically connected and mechanically fixed by a metallurgical bond such as a weld to the electrode 22. A distal end 46 of the resistance heating element 24 is electrically connected and mechanically fixed by a metallurgical bond to the closed end 32 of the sheath 20. This mechanical attachment and metallurgical bond is formed when the distal end 46 of the resistance heating element 24 is welded to the distal end 48 of the sheath preform 36 (FIG. 6). This weld also forms the closed end 32 of the tubular sheath 20 by sealing an opening 50 in the distal end of the preform 36.

An electrically insulating, thermally conductive packing of powder 26 is disposed within the sheath 20 and surrounds the resistance heating element 24. The powder 26 may include any suitable electrically insulating and thermally conductive powder to surround resistance heating elements known to those with skill in the art. Loose powder is inserted into a cavity 32 of the preform 36, through the annular gap around the electrode 22 following closure of the opening 50 by the associated weld which attaches the resistance heating element 24 to the sheath 20. The thickness of the annular gap may be any suitable thickness; however it is believed that a width of annular gap in the range of 0.2-1.0 mm will be useful for many applications of resistance heater assemblies 18. The width of the annular gap is determined by the radial difference of the inside diameter of the sheath preform 36 and the outer diameter of electrode 22 in the reduced diameter portion 34. In an exemplary embodiment of the invention, the powder 26 is fabricated from a magnesium oxide compound which is compacted around the resistance heating element 24 in conjunction with reducing the diameter of the sheath preform 36 to form the finalized sheath 20. The compacted magnesium powder 26 provides the desired thermal conductivity while also electrically isolating the resistance heating element 24 from the sheath 20. The powder 26 must also be operative for use over the extended operating temperature range of the glow plug 10, namely up to about 600-800° C.

A discrete insulating layer is formed along that portion of the electrode 22 passing through the reduced diameter portion 34 of the sheath 20. The insulating layer 54 preferably comprises a non-organic and non-elastomeric insulating material. This material may, in a preferred embodiment, comprise a glass or a ceramic material. If selected from a glass material, it may be formed from either a silicate glass, a borate glass, or a borosilicate glass. When made from a ceramic material, the insulating layer 54 may be fabricated from a metal oxide, a metal nitride or a metal oxynitride. Of course, other suitable materials may become apparent to those with skill in the art. The insulating layer 54 can be applied by any conventional technique including physical vapor deposition (PVD) which is a variety of vacuum deposition in which the materials to be deposited are heated to a high vapor pressure and then allowed to condense onto the target surface which, in this case, is the outer surface 38 of the electrode 22. Insulating layer 34 is effective to establish electrical insulation between the electrode 22 and the seal 28, and also to provide the surface against which the seal 28 can establish adequate adhesion and purchase.

The seal 28 is of metallic composition and therefore electrically conductive. Thus, the insulating layer 54 is needed to prevent electrical conductivity directly between the grounded sheath 20 and the charged electrode 22. The metal seal 28 can be formed as either a weld joint, a brazed joint, or a sintered powder metal joint. Various materials can be used to fabricate the metal seal 28, including copper and/or copper alloys, silver and alloys thereof as well as transition metals forming constituents of copper and silver alloys. One common transition metal used in these alloys can include titanium.

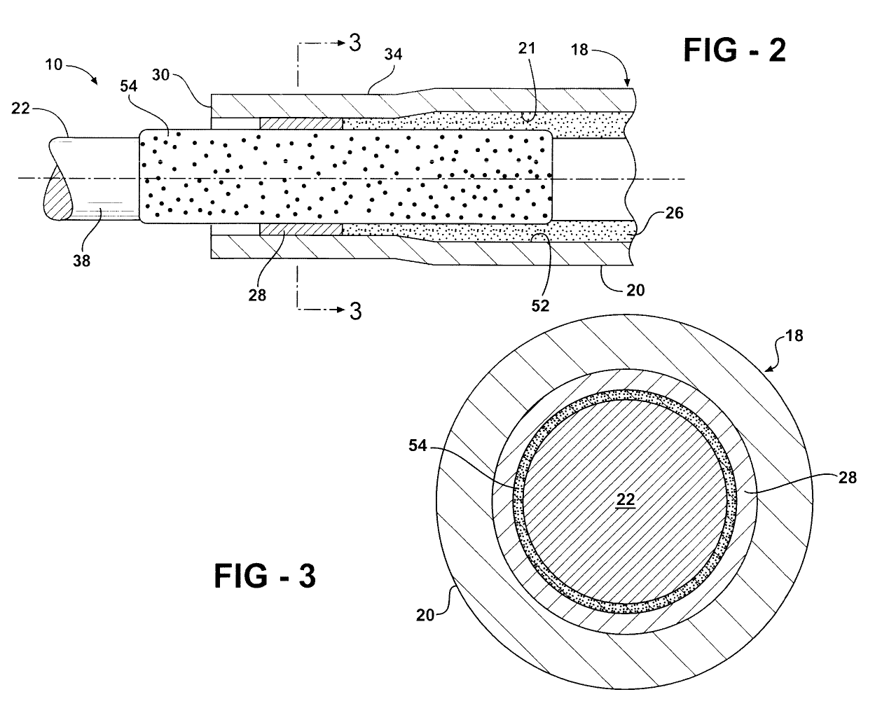

Thus, as shown in the FIGS. 1-3, the seal 28 is located in the open end 30 of the sheath 20 and is in sealing engagement with the sheath 20 in the insulating layer 54 through the annular gap therebetween. Thus, following insertion of the powder 26 into the cavity 52, the metal seal 28 is applied through either welding, brazing or sintering so as to bond the outer surface of the insulating layer 54 to the inner surface of the sheath 20. In this manner, the seal 28 forms a hermetic closure thus preventing any contaminants, including combustion gases and ambient oxygen or water vapor, from penetrating into the cavity 56 and thus reacting with the powder 26. By providing a hermetic seal, the incorporation of the metal seal 28 eliminates or substantially reduces the ability of such contaminants to interact with the powder 26 and the resistance heating element 24 as described above. This, in effect, reduces degradation of the resistance heating element 24 and increases its operating life.

In order to provide adequate electrical isolation between the electrode 22 and the sheath 20, the insulating layer 54 preferably has a resistance of at least about 1,000 ohms for applied voltages of up to 24 volts DC over the operating temperature range of the heater assembly 18, which is about −40-800° C. The insulating layer 24 must have mechanical strength, both in tensile and shear modes, throughout its thickness and at the interfaces with the electrode 22 and the metal seal 28, to resist an external applied pressure of up to 10 bars.

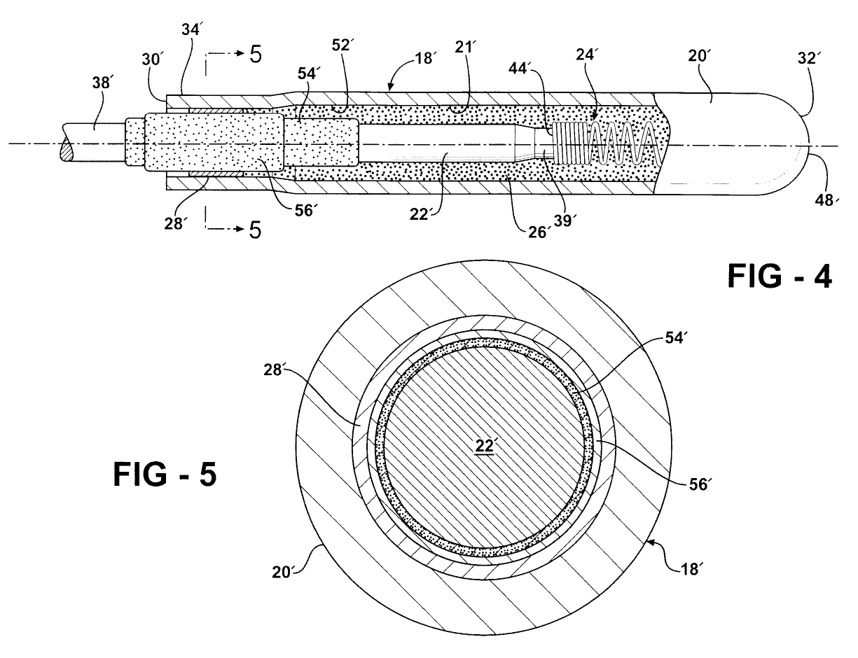

FIGS. 4 and 5 depict an alternative embodiment of this invention, wherein prime designations indicate like or corresponding parts with the first embodiment described above. In this embodiment, a secondary metal layer 56′ is disposed on the insulating layer 54′. The metal seal 28′ is thus formed in sealing engagement between the sheath 20′ and the secondary metallic layer 56′. The secondary metal layer 56′ may comprise a thin metal coating of the same or compatible metal as that of the seal 28′ so as to achieve even more improved adhesion characteristics. The secondary metal layer 56′ can be applied in controlled settings within a manufacturing environment, including the above-described PVD techniques, so that superior bonding can be achieved directly to the exterior surface of the electrode 22′. Following this, the seal 28′ of the same or metallurgically compatible material can be applied and bonded readily so as to perfect the hermetic closure described above.

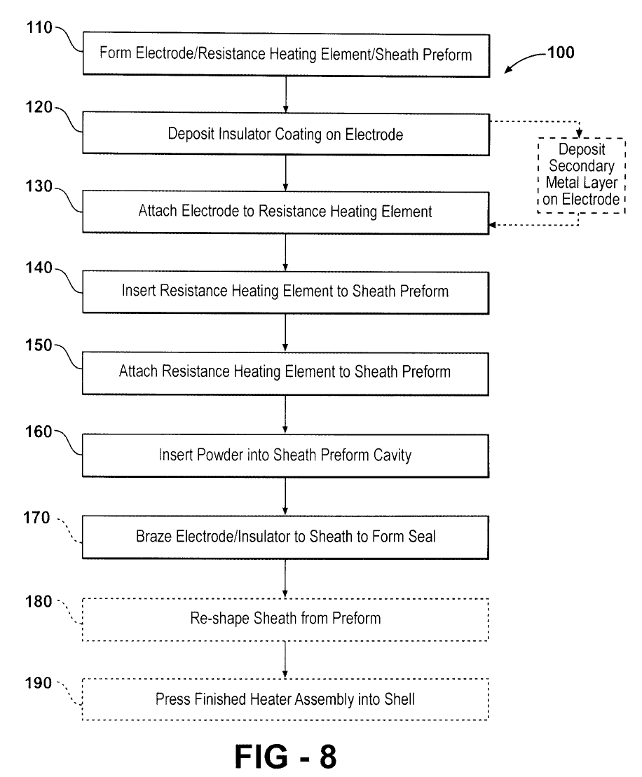

Referring to FIG. 8, a method 100 of making a heater assembly 18 for a glow plug 10 according to this invention is depicted in schematic form. Function block 110 comprises the steps of forming an electrode 22, a resistance heating element 24 and a sheath preform 36. In function block 120, insulating layer 54 is deposited as a coating over the exterior surface of the electrode 22. As an optional step, as depicted in broken lines, the secondary metal layer 56 can also be deposited over the insulating layer 54 following the depositing step 120. The electrode 22 is attached to the resistance heating element 24 at function block 130, and then the sub-assembly is inserted into the sheath preform 36 at function block 140. Thereafter, the resistance heating element 24 is attached to the sheath preform 36 at its distal end 48, as represented in function block 150. Next, function block 160 represents the step of inserting the powder 26 into the sheath cavity 52, followed by forming the seal 28 by either brazing or alternatively welding or sintering the metallic composition into the annular gap. Function block 180 is represented in broken lines as being an optional step comprising reshaping of the sheath 20 from the sheath preform 36 by any suitable rolling, stamping, pressing, extrusion or hydrostatic operation. Function block 190 represents the step of pressing the finished heater assembly 18 into the shell 20 and securing it therein as described above and according to traditional techniques.

By eliminating the use of an elastomeric seal in favor of a metal seal 28 which has a much higher melting point and superior high temperature mechanical and electrical properties, a glow plug 10 of this invention is adapted for operation at temperatures greater than 200° C. More particularly, the glow plug 10 can be adapted for operation at temperatures greater than 600° C., and even more particularly adapted for operation up to about 800° C. Furthermore, the metal seal 28 eliminates or greatly reduces the ability of ambient atmosphere to reach the powder bed 26 and wire heating element 24 and thereby cause degradation of the wire heating element.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A glow plug, comprising:
a metal shell having an axially extending bore;
an electrically and thermally conductive tubular sheath having an open end disposed within said bore in electrical contact with said shell and a closed end projecting from said bore;
an electrode having an embedded section extending into said open end of said sheath, said embedded section having a discrete insulating layer thereon;
a resistance heating element disposed in said sheath having a proximal end which is electrically connected to said embedded section of said electrode and a distal end electrically connected to said closed end of said sheath;
an electrically insulating, thermally conductive powder disposed within said sheath and surrounding said embedded end of said electrode and said resistance heating element; and
a metal seal disposed in said open end of said sheath in sealing engagement with said sheath and said insulating layer of said electrode.

2. The glow plug of claim 1, wherein said metal seal comprises a weld joint.

3. The glow plug of claim 1, wherein said metal seal comprises a braze joint.

4. The glow plug of claim 1, wherein said metal seal comprises a sintered metal powder.

5. The glow plug of claim 1, wherein said metal seal comprises a copper alloy or silver alloy.

6. The glow plug of claim 5, wherein said metal seal further comprises a transition metal as a constituent of said copper alloy or said silver alloy.

7. The glow plug of claim 6, wherein said transition metal is titanium.

8. The glow plug of claim 1, wherein said insulating layer comprises a non-organic, non-elastomeric insulating material.

9. The glow plug of claim 1, wherein said insulating layer comprises a glass or ceramic.

10. The glow plug of claim 9, wherein said insulating layer is a glass selected from the group consisting of a silicate glass, a borate glass and a borosilicate glass.

11. The glow plug of claim 9, wherein said insulating layer is a ceramic selected from the group consisting of a metal oxide, a metal nitride and a metal oxynitride.

12. A glow plug, comprising:
a metal shell having an axially extending bore;
an electrically and thermally conductive tubular sheath having an open end disposed within said bore in electrical contact with said shell and a closed and projecting from said bore;
an electrode having an embedded section extending into said open end of said sheath, said embedded section having a discrete insulating layer thereon;
a resistance heating element disposed in said sheath having a proximal end which is electrically connected to said embedded section of said electrode and a distal end electrically connected to said closed end of said sheath;
an electrically insulating, thermally conductive powder disposed within said sheath and surrounding said embedded end of said electrode and said resistance heating element;
a metal seal disposed in said open end of said sheath in sealing engagement with said sheath and said insulating layer of said electrode; and
a secondary metal layer disposed on said insulating layer, wherein said metal seal is in sealing engagement between said sheath and said secondary metal layer.

13. The glow plug of claim 12, wherein said metal seal comprises a weld joint.

14. The glow plug of claim 12, wherein said metal seal comprises a braze joint.

15. The glow plug of claim 12, wherein said metal seal comprises a sintered metal powder.

16. The glow plug of claim 12, wherein said metal seal comprises a copper alloy or silver alloy.

17. The glow plug of claim 16, wherein said metal seal further comprises a transition metal as a constituent of said copper alloy or said silver alloy.

18. The glow plug of claim 17, wherein said transition metal is titanium.

19. The glow plug of claim 12, wherein said insulating layer comprises a non-organic, non-elastomeric insulating material.

20. The glow plug of claim 12, wherein said insulating layer comprises a glass or ceramic.

21. The glow plug of claim 20, wherein said insulating layer is a glass selected from the group consisting of a silicate glass, a borate glass and a borosilicate glass.

22. The glow plug of claim 20, wherein said insulating layer is a ceramic selected from the group consisting of a metal oxide, a metal nitride and a metal oxynitride.

23. A method of making a heater assembly for a glow plug which includes an electrically and thermally conductive tubular sheath having an open end and a closed end; an electrode having an embedded section extending into the open end of the sheath, the embedded section having an insulating layer thereon; an electrically insulating, thermally conductive powder disposed within the sheath and surrounding the resistance heating element; and a metal seal disposed in the open end of the sheath in sealing engagement between the sheath and the insulating layer; said method comprising the steps of:
forming a tubular sheath, electrode and resistance heating element;
forming an insulating layer on at least a portion of the embedded section of the electrode;
attaching one end of the resistance heating element to the embedded section of the electrode;
inserting the resistance heating element and the embedded section of the electrode into the tubular sheath;
attaching another end of the resistance heating element to the closed end of the sheath;
inserting the powder into the sheath around the resistance heating element; and
forming the metal seal between the sheath and the insulating layer.

24. The method of claim 23, further including the step of forming a secondary metal layer on the insulating layer before said step of forming a metal seal.

25. The method of claim 23, wherein said step of forming the metal seal comprises welding, brazing or sintering.

26. The method of claim 23, further comprising the step of attaching the heater assembly to a metal glow plug shell.
